(19) United States
(12) Patent Application Publication
(10) Pub. No.: US 2025/0090964 A1
(43) Pub. Date: Mar. 20, 2025

(54) COLLECTION AND REDEMPTION OF NFT'S PRE-GAME RELEASE

(71) Applicant: IGT, Las Vegas, NV (US)

(72) Inventors: Todd GRIMM, Riverview (CA); Karen VAN NIEKERK, Dieppe (CA); Bethany PLIMMER, Lower Coverdale (CA); Michael RUSS, Graz (AT)

(73) Assignee: IGT, Las Vegas, NV (US)

(21) Appl. No.: 18/468,208

(22) Filed: Sep. 15, 2023

(51) Int. Cl. A63F 13/792; A63F 13/35

(52) U.S. Cl. CPC A63F 13/792; A63F 13/35; A63F 2300/609

(57) ABSTRACT

A system includes a communication interface, a processing circuit, and a memory coupled to the processing circuit. The memory includes machine readable instructions that, when executed by the processing circuit, cause the processing circuit to perform operations of providing, using a processor circuit and to a portion of players, multiple digital game assets that correspond to a new game before the new game is released for public access, wherein a digital asset includes a non-fungible token that includes a cryptographic asset including a unique identification code, wherein the selected portion of players includes a player focus group that includes multiple players that provide feedback corresponding to the new game before the new game is released. Operations include collecting player data corresponding to the player based on the player's usage of the digital game asset and modifying a value of the digital game asset based on the player data collected.

### BACKGROUND

Embodiments described herein relate to gaming systems and methods. Gaming devices, such as electronic gaming machines (EGMs) and/or other wagering terminals may be capable of attracting players based on access to wagering opportunities. Increasing social gaming wagering opportunities and interfaces may provide increased interest in wagering.

Social gaming interaction features employing cryptographic tokens and token functionality, and related devices, systems, and methods may increase player access to various options for player interaction. For example, FTs and/or NFTs may provide additional options for player interaction and enjoyment to encourage wagering game play.

### BRIEF SUMMARY

Embodiments herein are directed to systems that include a communication interface, a processing circuit, and a memory coupled to the processing circuit. The memory may include machine readable instructions that, when executed by the processing circuit, cause the processing circuit to perform operations described herein. Some embodiments include providing, to a portion of players, multiple digital game assets that correspond to a new game before the new game is released for public access. In some embodiments, a digital asset of the digital game assets includes one of a non-fungible token, NFT, that is a cryptographic asset including a unique identification code. Each NTF is distinguishable from other ones of the digital game assets or a fungible token, FT, that is exchangeable for another FT that includes a same value as another FT. In some embodiments providing the NFT or the FT includes transferring the NFT or the FT to a player digital wallet before the new game is released.

In some embodiments, providing the digital game assets includes providing a physical object that includes NFT data. The physical object may include the FT and, in response to redeeming the FT, the NFT is transferred to the player. Further, some embodiments provide that the digital game assets that correspond to a new game before the new game is released for public access include a mystery item that is available for purchase before the new game is released. In such embodiments, the mystery item includes a prerelease NFT. Embodiments further include collecting player data corresponding to the player based on usage of the digital game asset by the player.

Some embodiments are directed to methods that include operations of providing using a gaming establishment component processor and to a portion of players, multiple digital game assets that correspond to a new game before the new game is released for public access. In some embodiments, a digital asset of the multiple digital game assets includes a non-fungible token, NFT, that includes a cryptographic asset having a unique identification code. In some embodiments, the portion of players includes a player focus group that includes multiple players that provide feedback corresponding to the new game before the new game is released. In some embodiments, the player focus group includes a first player, a second player and a third player of the multiple players. Some embodiments include collecting player data corresponding to the player based on usage of the digital game asset by the player. Some embodiments further include modifying a value of the digital game asset based on the player data collected.

Some embodiments are directed to a system that includes a gaming establishment component processor and a gaming establish component memory device coupled to the gaming establishment component processor. The memory includes machine readable instructions that, when executed by the gaming establishment component processor, cause the gaming establishment component processor to perform operations of providing, to a player in a portion of players, multiple digital game assets that correspond to a new game before the new game is released for public access and collecting player data corresponding to the player based on usage by the player of the digital game asset.

BRIEF DESCRIPTION OF SEVERAL VIEWS OF THE DRAWINGS

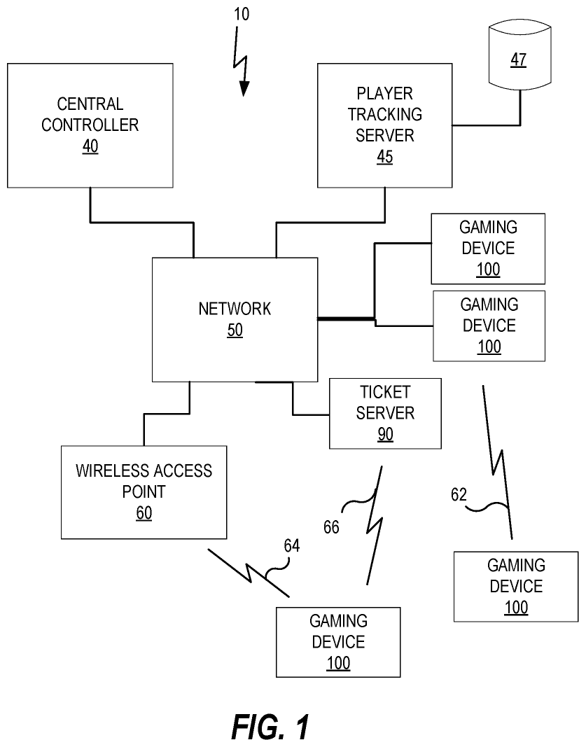

FIG. 1 is a schematic block diagram illustrating a network configuration for a plurality of gaming devices according to some embodiments.

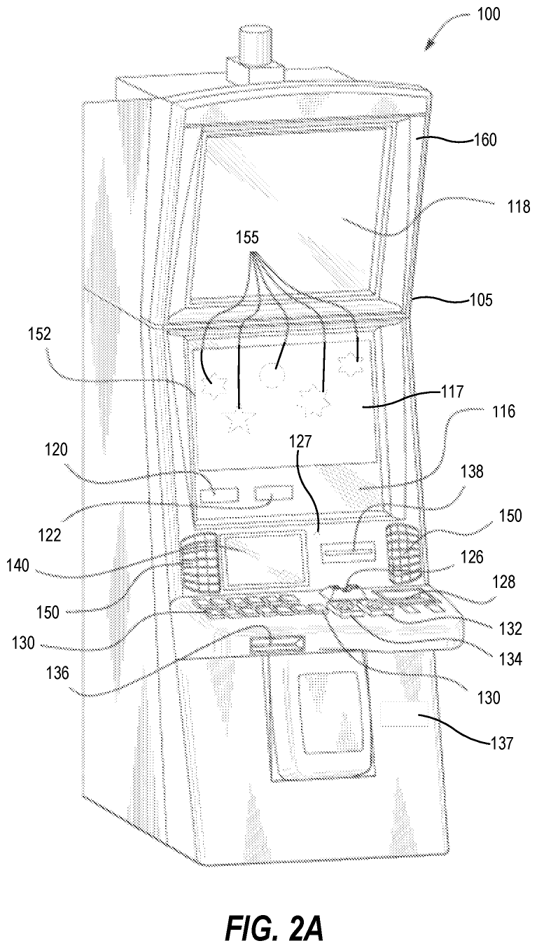

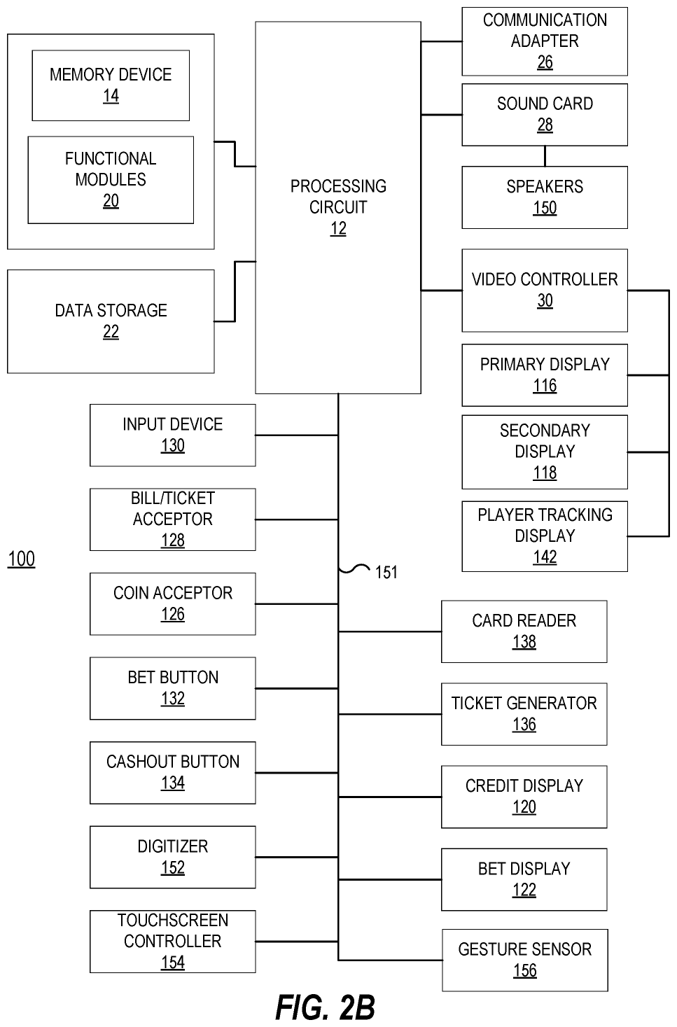

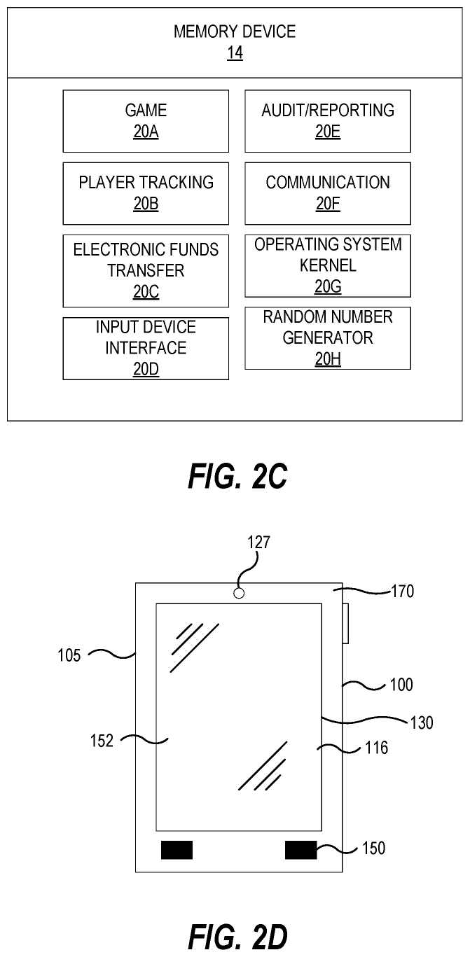

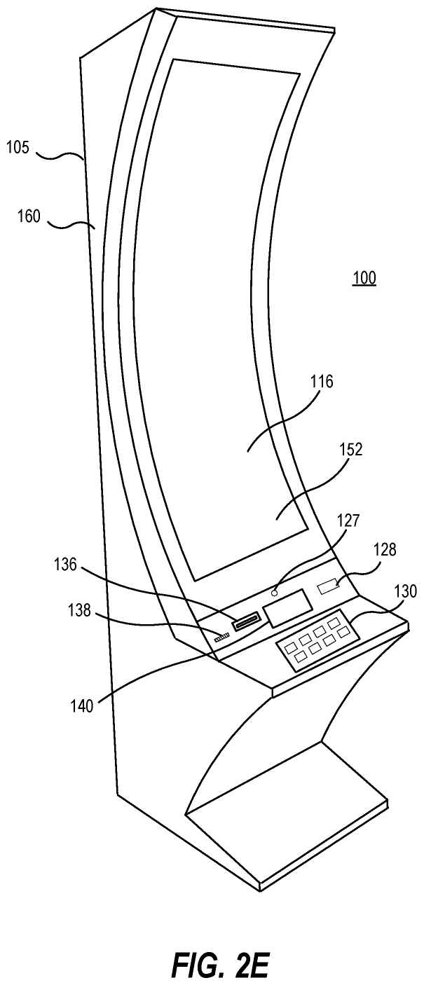

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is perspective view of a gaming device that can be configured according to some embodiments.

FIG. 2E is a perspective view of a gaming device according to further embodiments.

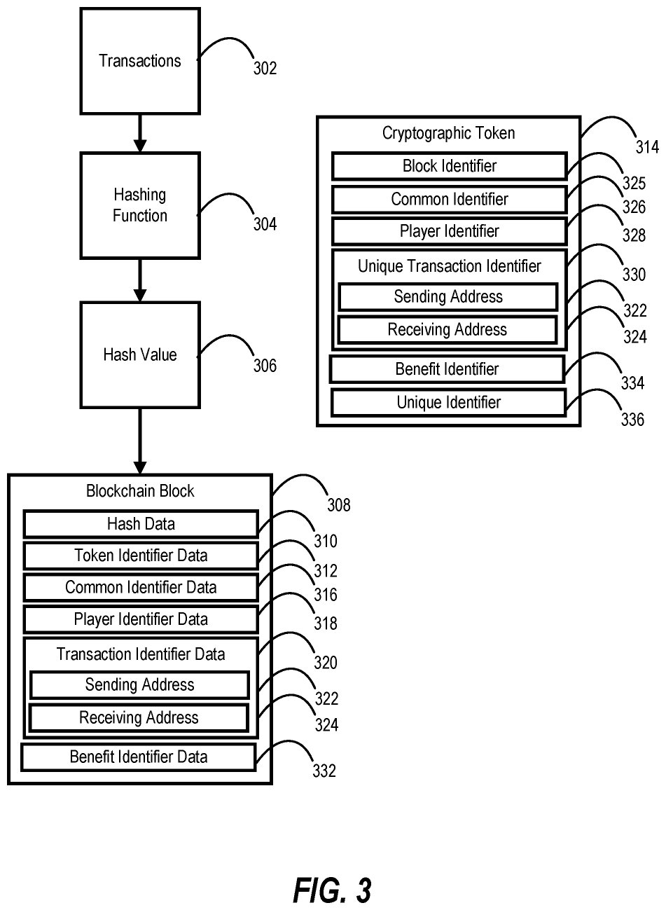

FIG. 3 a schematic block diagram illustrates various operations for a blockchain transaction recordation according to some embodiments.

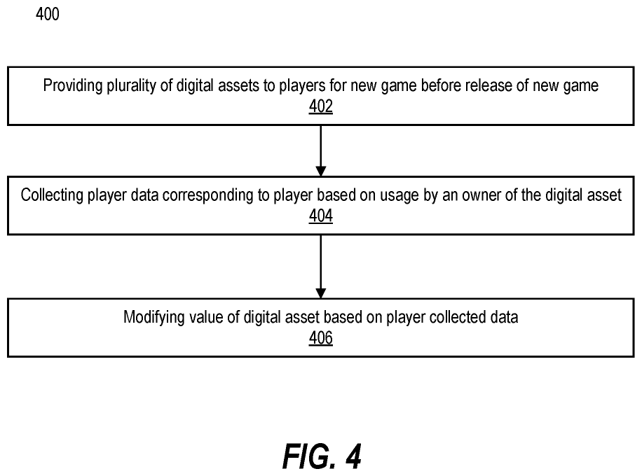

FIG. 4 is a flowchart illustrating operations of systems/methods/devices for providing collection and redemption of NFTs Pre-game release, according to some embodiments.

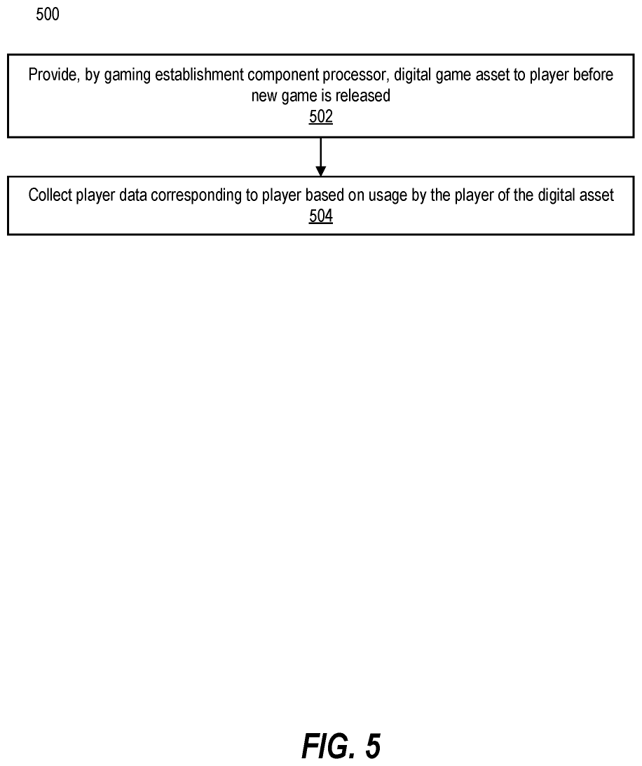

FIG. 5 is a flowchart illustrating operations of systems/methods/devices for providing collection and redemption of NFTs Pre-game release, according to some embodiments.

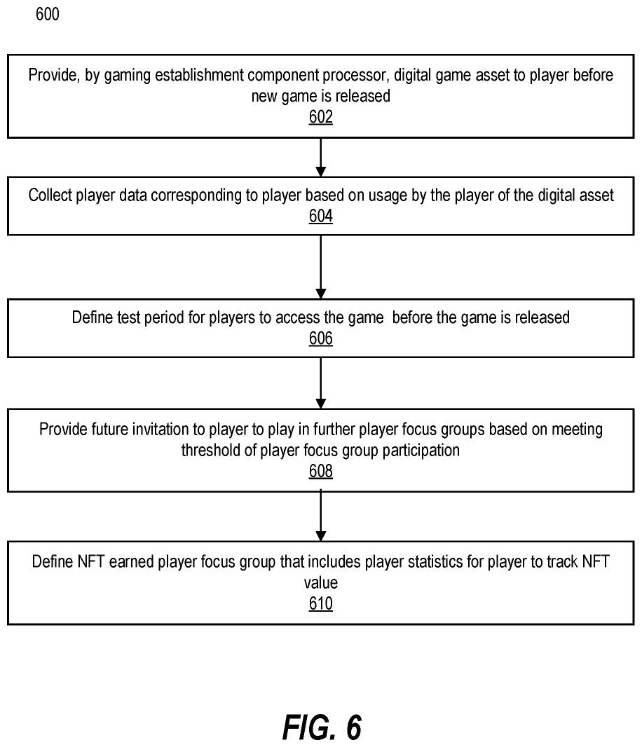

FIG. 6 is a flowchart illustrating operations of systems/methods/devices for providing collection and redemption of NFTs Pre-game release, according to some embodiments.

### DETAILED DESCRIPTION

As provided herein, non-fungible tokens (NFTs) are assets that have been tokenized via a block chain. These NFTs may be assigned unique identification codes and/or metadata that distinguishes them from other tokens. Some embodiments rely on an exchange to create a token for a given image. In some cases, such tokens may be deemed highly valuable by some and worth very little to others. Some embodiments provide that some NFT's may appear the same but are not interchangeable based on other data and/or features. NFTs may represent digital and/or real-world items. Some embodiments provide that tokenizing real-world items as tangible assets to improve the efficiency of buying, selling and/or trading and/or may lower a risk of fraud.

Embodiments herein may provide the opportunity to get early access or be part of a select group to be the first to play new games when they are launched into the casino space. In some embodiments, the ability to track these players will be through the use of collected and/or redeemed fungible tokens (FTs) and/or non-fungible tokens (NFTs).

In some embodiments, a specific group of players may be granted access to these FTs/NFTs even before the launch of the game. For example, players in a focus group who provide valuable feedback to the pre-released game; or “very loyal” provider players may be recognized for their loyalty or even a randomized pick based on pre-game-release sign ups, etc.

In some embodiments, new game releases may be accompanied by a finite set of tokens that form part of the game assets for that particular title. According to some embodiments, the finite set of tokens may add value to new title releases.

In some embodiments, other solutions to current problems that may be addressed by embodiments herein may create stronger interest of players for not-yet-released games. For example, players may be more thrilled by new games if they know they have a chance of getting “parts of the game” (FTs/NFTs) even before other players.

In some embodiments, for player focus groups, the provision of FTs and/or NFTs may encourage players to provide valuable feedback and carefully consider their opinions about a pre-released game. One reason may include that, in addition to only getting money for showing up at the PFG, the players may also get the chance of getting something special as a “token of appreciation” when provided valuable feedback.

Some embodiments provide that the pregame release FTs and/or NFTs may provide a mechanism to identify pioneer players, that may be eligible for early testing, instead of a random selection of players for testing a game. Further, some embodiments provide that a stronger loyalty bonding to a particular manufacturer's games may provide direct feedback and gaining something game-related in return.

Embodiments herein may include and/or integrate technologies including NT, blockchain, crypto minting, distribution and/or marketplace and/or player user data, among others.

In some embodiments, the current technical properties of FTs and NFTs and may be applied to the gambling/wagering space. Specific pieces of information can be stored on the token(s) that are personalized based on the player's participation in game review before they are launched to the field. This may provide special privileges when the game is released. Cooperatively, players gaming habits on certain games can award NFTs that can subsequently be used to participate in future pre-game release reviews, perhaps involving similar type games.

Some embodiments provide that player focus groups may provide a method of delivering tokens. For example, using a player focus group in a certain market, an offer for the opportunity for these players to be the first to play the game may be provided if and when it comes to their local casino.

Some embodiments provide that different tokens may have different levels of access and/or reward. For example, a bronze token may be redeemable just for participating. Based on the bronze token, the player may be able to redeem the token and play the game when it's released. In some embodiments, the player may earn a monetary reward, such as, for example, $20. In some embodiments, the player may insert some monetary amount and then get to play more than the amount that was deposited. For example, a $20 deposit may earn $20 in free play. Ins some embodiments, the player may not be able to cashout until at least $40 has been played.

Continuing with the example above, if during the player focus group the player indicates that they really like the game and would play it once it's released, a silver token may be redeemable to play with $50 in free play. Similarly, for a player that really likes that game and provides specific feedback regarding the new release, the gold token may be redeemable and get $100 in free play.

In some embodiments, player data may be received from a casino or other entity to determine which players would earn which tokens to be added to a player's account or card. Some embodiments provide that that the token may be a physical token first, such as a voucher card.

In some embodiments, the voucher card may be themed with a theme corresponding to the game theme. The voucher card may show its FT value and/or its NFT asset and may include the terms and conditions about where and when the voucher card may be redeemed. Some embodiments provide that, once activated, the respective game in the venue turns into a digital token.

In some embodiments, the token may be a digital token without a corresponding physical token and may be stored in a player's crypto wallet. Some embodiments provide that the token may be redeemed and/or traded directly from there, once available.

In some embodiments, a player in the player focus group may be provided feedback to a specific game and that caused a specific symbol to be changed. In such embodiments, the player may be provided with an NFT of this specific symbol. In some embodiments, this player may become the “true owner” of this specific symbol that no one else may have. Some embodiments provide that this player might receive an NFT that shows a symbol animation from the older version of the symbol into the new version. Some embodiments provide that during a game, when having a win, only this player's symbol animation shows the transformation from old to new. In such embodiments, the player may be able to show their impact on the symbol to other players in the player focus group. Such embodiments may be applicable to various types of content including symbols, music, animations, and/or background, among others.

In some embodiments, a player in a PFG may be provided a level of sorting based on game types they've tested in the past PFGs they've attended. For example, if we have a player who has participated in multiple (more than one PFG) and we know what type of game was the preferred in previously attended PFG(s), the order of the new games being presented may rearrange from ‘most likely to meet the players preference’ to ‘least likely to meet the players preference’ onscreen. If the order or accuracy of the arrangement is correct, based on answering a question, there could be a special FT/NFT awarded to the player that confirms their preferred types of games and/or participation in the session.

Some embodiments may provide the player who completes their participation in a PFG an ‘open’ or ‘info collecting’ token that will record each game the player goes to play. In some embodiments, this information may be useful in validating the players' favorite games they like to play, what games they are drawn to initially, keep information as far as casinos visited, time spent, games played, repeat games played, bet played, bonuses played, etc. to see how long a player plays a game to then give it judgement as ‘not liking’ or ‘love playing’. Some embodiments provide that the token, when brought to the next PFG may be ‘read’ or ‘scanned’ to then provide valuable information back to the company. In exchange the player may be leveled up in token value, such as, for example, a bronze, silver, and/or gold token value.

In some embodiments, a mystery digital asset purchase may provide that a mystery item can be purchased in advance of the game launching. The mystery digital asset may include weighted contents related to the game. In some embodiments, the highest value assets may be limited run NFTs, but other items may include FTs, free play and/or other digital merchandise that is related to that particular title. In some embodiments, a player may sign up to receive a notification of the game's release. Some embodiments provide that every sign up has the chance of receiving a mystery “early game release” token for this game (FT/NFT). In such embodiments, the player may play the game within a given amount of time after release to unlock their token and keep it forever.

Some embodiments provide that early adopters/players may add value to NFTs by enabling them when playing the specific new title. In some embodiments, a NFT used in the game may gain value from being played within a certain time frame, such as during test bank period. Some embodiments provide that he gain in value may correspond to an added a date stamp to the NFT that commemorates that first time playing that title. In some embodiments, the feature may only be available during a certain time period.

In some embodiments, an early adopter NFT may facilitate further benefits and/or advantages. For example, some embodiments provide that players that enable and use their NFT meeting certain thresholds may “earn” reinvites to further player focus group sessions and other benefits such as merchandise. In some embodiments, players may track their progress to earning these rewards.

In some embodiments, a token-earned-based player focus group program provides every focus group player the ability to see their statistics regarding player focus group participation. Statistics may include status and/or identity of earned tokens and other related stats. Some embodiments provide that the more that a player participates in a player focus group, the greater the eligibility to earn more and/or better tokens.

Before describing these and other features in greater detail, reference is now made to FIG. 1, which illustrates a gaming system 10 including a plurality of gaming devices 100. The gaming devices 100 may be one type of a variety of different types of gaming devices, such as electronic gaming machines (EGMs), mobile gaming devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. The central controller 40 may be any suitable server or computing device which includes at least one processing circuit and at least one memory or storage device. Each gaming device 100 may include a processing circuit that transmits and receives events, messages, commands or any other suitable data or signal between the gaming device 100 and the central controller 40. The gaming device processing circuit is operable to execute such communicated events, messages or commands in conjunction with the operation of the gaming device 100. Moreover, the processing circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processing circuits. Moreover, in some embodiments, one or more of the functions of one or more gaming device processing circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processing circuit that transmits and receives events, messages, commands or any other suitable data or signal between the ticket server 90 and the central controller 40. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in

FIG. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously-placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Although illustrated as certain gaming devices, such as electronic gaming machines (EGMs) and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Referring now to FIG. 3, a schematic block diagram illustrates various operations for a blockchain transaction recordation according to some embodiments. As illustrated in FIG. 3, transactions 302 may occur at various blockchain nodes. In accordance with various embodiments, a hash may be created for each entry. For example, a cryptographic hash function may create a one-way, (essentially) collision free signature of the entry. The hash algorithm generates a hash. Using hashing function 304, hash values 306 of these transactions are created and added to blockchain blocks 308 that are in the blockchain data structure.

In this example, each blockchain block 308 may include one or more different types of data. For example, each blockchain block 308 may include cryptographic hash data 310 indicative of a result of the hashing function 304 associated with a common blockchain, token identifier data 312 indicative of an identity of a cryptographic token 314 associated with the block 308, common identifier data 316 indicative of the cryptographic token 314 being part of a plurality of cryptographic tokens, e.g., a defined subset of tokens based on different criteria, associated with the common blockchain, player identifier data 318 indicative of an identity of a player associated with the cryptographic token 314, transaction identifier data 320 associated with the unique transaction on the blockchain, which may include a sending address 322 associated with a provider of the cryptographic token 314 and a receiving address 324 associated with the player identifier data 318.

In some examples, each block 308 may further include benefit identifier data 332 associated with a game benefit being provided to the player associated with the cryptographic token 314. Alternatively or in addition, the cryptographic token 314 may include a benefit identifier 334 corresponding to the benefit and/or benefit identifier data 332. Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

The cryptographic token 314 may include some or all of the data structure of the respective associated block 308 and/or may contain a block identifier 325 referring to the associated block 308, which allows the cryptographic token 314 to be securely and transparently authenticated against the blockchain. In some examples, the cryptographic token 314 may include a common identifier 326 corresponding to the common identifier data 316 and indicative of the cryptographic token 314 being part of the plurality of cryptographic tokens, and a player identifier 328 corresponding to the player identifier data 318 and indicative of a player associated with the cryptographic token 314. The cryptographic token 314 may include a unique transaction identifier 330 associated with a unique transaction on the blockchain, i.e., a unique block 308, and may include the sending address 322 and/or the receiving address 324.

For example, a new transaction for the cryptographic token may include transmitting a transaction indication of the new transaction including a sending address 322 and receiving address 324, and, based on the transaction indication, modifying the player identifier data 318 in a new block 308 and/or the player identifier 328 of the cryptographic token 314 to be indicative of a different player.

In some examples, each block 308 may further include benefit identifier data 332 associated with a game benefit being provided to the player associated with the cryptographic token 314. Alternatively or in addition, the cryptographic token 314 may include a benefit identifier 334 corresponding to the benefit and/or benefit identifier data 332. Each cryptographic token 314 may be a fungible token that is fungible with other cryptographic tokens, and/or may further include a unique identifier 336, which may correspond to the token identifier data 312 of the block 308, such that the cryptographic token 314 is a non-fungible token that is not fungible with other cryptographic tokens.

As a general principle, a validation process may be performed to ensure that each new blockchain block 308 meets the criteria for inclusion into the blockchain data structure. In a blockchain configuration, there are varying consensus algorithms that can be used. For example, a private blockchain may choose an algorithm such as Practical Byzantine Fault Tolerance (PBFT). The PBFT mechanism may be useful for small networks, such as networks having fewer than about 100 nodes. Other examples include a Proof of Work (PoW) consensus algorithm and/or a Proof of Stake (PoS) consensus algorithm, which may be used as the value of an underlying data block and/or value changes.

Reference is now made to FIG. 4, which is a flowchart illustrating operations of systems/methods/devices for providing collection and redemption of NFTs pre-game release, according to some embodiments. Some embodiments include providing (block 402) using a gaming establishment component processor and to a portion of players, multiple digital game assets that correspond to a new game before the new game is released for public access. In some embodiments, a digital asset of the multiple digital game assets includes a non-fungible token, NFT, that includes a cryptographic asset having a unique identification code. In some embodiments, the portion of players includes a player focus group that includes multiple players that provide feedback corresponding to the new game before the new game is released. In some embodiments, the player focus group includes a first player, a second player and a third player of the multiple players.

Some embodiments include collecting (block 404) player data corresponding to the player based on usage of the digital game asset by the player. Some embodiments further include modifying (block 406) a value of the digital game asset based on the player data collected.

Brief reference is now made to FIG. 5, which is a flowchart illustrating operations of systems/methods/devices for providing collection and redemption of NFTs pre-game release, according to some embodiments. Some embodiments include providing (block 502), to a portion of players, multiple digital game assets that correspond to a new game before the new game is released for public access. In some embodiments, a digital asset of the digital game assets includes one of a non-fungible token, NFT, that is a cryptographic asset including a unique identification code. Each NTF is distinguishable from other ones of the digital game assets or a fungible token, FT, that is exchangeable for another FT that includes a same value as the another FT. In some embodiments providing the NFT or the FT includes transferring the NFT or the FT to a player digital wallet before the new game is released.

In some embodiments, providing the plurality of digital game assets includes: providing a physical object that includes NFT data. The physical object may include the FT and, in response to redeeming the FT, the NFT is transferred to the player. Further, some embodiments provide that the digital game assets that correspond to a new game before the new game is released for public access include a mystery item that is available for purchase before the new game is released. In such embodiments, the mystery item includes a prerelease NFT.

Embodiments further include collecting (block 504) player data corresponding to the player based on usage of the digital game asset by the player.

Reference is now made to FIG. 6, which is a flowchart illustrating operations of systems/methods/devices for providing collection and redemption of NFTs pre-game release, according to some embodiments.

While some embodiments are directed to a system that includes a gaming establishment component processor, some embodiments are not so limited. For example, some embodiments may include a processing circuit. Operations corresponding to some embodiments include providing (block 602), to a player in a portion of players, multiple digital game assets that correspond to a new game before the new game is released for public access. In some embodiments, each NFT represents a real-world tangible asset and the NFT is transferable to another player.

In some embodiments, providing the NFT includes transferring the NFT to a player digital wallet before the new game is released.

Operations according to some embodiments include collecting (block 604) player data corresponding to the player based on usage by the player of the digital game asset.

In some embodiments, a digital asset of the multiple digital game assets includes a non-fungible token, NFT, that comprises a cryptographic asset comprising a unique identification code, wherein each NTF is distinguishable from other ones of the digital game assets. In some embodiments, the portion of players includes a player focus group that includes players that provide feedback corresponding to the new game before the new game is released.

Some embodiments provide that the player focus group includes a first player, a second player and a third player of the players. In some embodiments, in response to the first player having a participation in the player focus group without providing comment, the digital game asset includes a first NFT having a first value to the first player.

Some embodiments provide that, in response to the second player providing favorable feedback that indicates that the second player would play the game, the provided digital asset includes a second NFT that includes a second value to the second player. In some embodiments, the second value is greater than the first value.

In some embodiments, in response to the first, second or third players providing a feedback that causes a specific symbol to be changed, providing includes providing the specific symbol in an NFT to a corresponding one of the first, second or third players. Some embodiments provide that, in response to the specific symbol providing a feedback that causes the specific symbol to be changed, providing includes animating the specific symbol and providing an animated specific symbol to the corresponding to one of the first, second or third players. In some embodiments, in response to the third player providing favorable feedback that provides suggested areas for improving the game, a third NFT including a third value is provided to the third NFT. Some embodiments provide that the third value is greater than the second value. In some embodiments, the first NFT includes multiple free games that correspond to an amount spent for purchased games.

In some embodiments, the digital game assets are provided as a physical object that includes NFT data. Some embodiments provide that the physical object includes a FT, and, in response to redeeming the FT, the NFT is transferred to the player.

In some embodiments, providing the digital game assets that correspond to a new game before the new game is released for public access may include providing a mystery item that is available for purchase before the new game is released. In some embodiments, the mystery item includes a prerelease NFT.

In some embodiments, the player is notified of the game's release in response to receiving a request for additional game information.

Some embodiments provide that the player is provided with additional value in the NFT in response to playing a specific new title.

Some embodiments provide that the gaming establishment component processor is further caused to define (block 606) a test period for the portion of players to access the game before the game is released. In some embodiments, in response to the player playing the game during the test period, additional value is added to the NFT used in the game.

Some embodiments provide that the gaming establishment component processor is further caused to provide (block 608) a future invitation to the player to play in further player focus groups based on player earning the future invitation by meeting a threshold of player focus group participation.

In some embodiments, the gaming establishment component processor is further caused to define (block 610) an NFT earned player focus group that includes player statistics corresponding to participation in the player focus group and to provide the player statistics to the player for the player to track progress in earning NFT value.

### EGM's

Embodiments described herein may be implemented in various configurations for EGMs 100s, including but not limited to: (1) a dedicated EGM, wherein the computerized instructions for controlling any games (which are provided by the EGM) are provided with the EGM prior to delivery to a gaming establishment; and (2) a changeable EGM, where the computerized instructions for controlling any games (which are provided by the EGM) are downloadable to the EGM through a data network when the EGM is in a gaming establishment. In some embodiments, the computerized instructions for controlling any games are executed by at least one central server, central controller or remote host. In such a “thin client” embodiment, the central server remotely controls any games (or other suitable interfaces) and the EGM is utilized to display such games (or suitable interfaces) and receive one or more inputs or commands from a player. In another embodiment, the computerized instructions for controlling any games are communicated from the central server, central controller or remote host to a EGM local processor and memory devices. In such a “thick client” embodiment, the EGM local processor executes the communicated computerized instructions to control any games (or other suitable interfaces) provided to a player.

In some embodiments, an EGM may be operated by a mobile device, such as a mobile telephone, tablet other mobile computing device. For example, a mobile device may be communicatively coupled to an EGM and may include a user interface that receives user inputs that are received to control the EGM. The user inputs may be received by the EGM via the mobile device.

In some embodiments, one or more EGMs in a gaming system may be thin client EGMs and one or more EGMs in the gaming system may be thick client EGMs. In another embodiment, certain functions of the EGM are implemented in a thin client environment and certain other functions of the EGM are implemented in a thick client environment. In one such embodiment, computerized instructions for controlling any primary games are communicated from the central server to the EGM in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal EGMs, such as desktop computers, laptop computers, tablet computers or computing devices, personal digital assistants (PDAs), mobile telephones such as smart phones, and other mobile computing devices.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In some embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

Embodiments provided herein may provide improved accessibility to wagering stations by including additional user interface technologies, such as virtual and/or augmented reality. Such embodiments may improve technological efficiency by coordinating the augmented reality with examples of different types of wagering stations.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a gaming establishment component processor; and
a gaming establishment component memory device which stores a plurality of instructions, which, when executed by the gaming establishment component processor, cause the gaming establishment component processor to:
provide, to a player in a portion of players, a plurality of digital game assets that correspond to a new game before the new game is released for public access; and
collect player data corresponding to the player based on usage by the player of the digital game asset.

2. The system of claim 1, wherein a digital asset of the plurality of digital game assets comprises a non-fungible token, NFT, that comprises a cryptographic asset comprising a unique identification code, wherein each NTF is distinguishable from other ones of the plurality of digital game assets.

3. The system of claim 2, wherein each NFT represents a real-world tangible asset, and wherein the NFT is transferable to another player.

4. The system of claim 2, wherein the portion of players comprises a player focus group that includes a plurality of players that provide feedback corresponding to the new game before the new game is released.

5. The system of claim 4, wherein the player focus group comprises a first player of the plurality of players, a second player of the plurality of players and a third player of the plurality of players,
wherein, in response to the first player having a participation in the player focus group without providing comment, the providing comprises providing a first NFT comprising a first value to the first player.

6. The system of claim 5, wherein, in response to the second player providing favorable feedback that indicates that the second player would play the game, the providing comprises providing a second NFT comprising a second value to the second player, wherein the second value is greater than the first value.

7. The system of claim 6, wherein in response to the first, second or third players providing a feedback that causes a specific symbol to be changed, the providing comprises providing the specific symbol in an NFT to a corresponding one of the first, second or third players.

8. The system of claim 7, wherein, in response to the specific symbol providing a feedback that causes the specific symbol to be changed, the providing comprises animating the specific symbol and providing an animated specific symbol to the corresponding to one of the first, second or third players.

9. The system of claim 7, wherein, in response to the third player providing favorable feedback that provides suggested areas for improving the game, the providing comprises providing a third NFT comprising a third value to the third player, wherein the third value is greater than the second value.

10. The system of claim 5, wherein the first NFT comprises a plurality of free games that corresponds to an amount spent for purchased games.

11. The system of claim 2, wherein providing the NFT comprises transferring the NFT to a player digital wallet before the new game is released.

12. The system of claim 2, wherein providing the plurality of digital game assets comprises providing a physical object that comprises NFT data, wherein the physical object comprises a fungible token, FT, and wherein, responsive to redeeming the FT, the NFT is transferred to the player.

13. The system of claim 2, wherein providing the plurality of digital game assets that correspond to a new game before the new game is released for public access comprises providing a mystery item that is available for purchase before the new game is released, wherein the mystery item comprises a prerelease NFT.

14. The system of claim 2, wherein responsive to receiving a request for additional game information, the player is notified of the game's release.

15. The system of claim 2, wherein, in response to playing a specific new title, the player is provided with additional value in the NFT.

16. The system of claim 2, wherein the gaming establishment component processor is further caused to define a test period for the portion of players to access the game before the game is released, wherein responsive to the player playing the game during the test period, additional value is added to the NFT used in the game.

17. The system of claim 2, wherein the gaming establishment component processor is further caused to provide a future invitation to the player to play in further player focus groups based on player earning the future invitation by meeting a threshold of player focus group participation.

18. The system of claim 2, wherein the gaming establishment component processor is further caused to define an NFT earned player focus group that comprises player statistics corresponding to participation in the player focus group and to provide the player statistics to the player for the player to track progress in earning NFT value.

19. A method comprising:
providing, using a gaming establishment component processor and to a portion of players, a plurality of digital game assets that correspond to a new game before the new game is released for public access, wherein a digital asset of the plurality of digital game assets comprises a non-fungible token, NFT, that comprises a cryptographic asset comprising a unique identification code, wherein the portion of players comprises a player focus group that includes a plurality of players that provide feedback corresponding to the new game before the new game is released, and wherein the player focus group comprises a first player of the plurality of players, a second player of the plurality of players and a third player of the plurality of players;
collecting player data corresponding to the player based on usage of the digital game asset by the player; and
modifying a value of the digital game asset based on the player data collected.

20. A system comprising:
a communication interface;
a processing circuit; and
a memory coupled to the processing circuit, the memory comprising machine readable instructions that, when executed by the processing circuit, cause the processing circuit to:
provide, to a portion of players, a plurality of digital game assets that correspond to a new game before the new game is released for public access, wherein a digital asset of the plurality of digital game assets comprises one of a non-fungible token, NFT, that comprises a cryptographic asset comprising a unique identification code, wherein each NTF is distinguishable from other ones of the plurality of digital game assets or a fungible token, FT, that is exchangeable for another FT that comprises a same value as the another FT,
and wherein providing the NFT or the FT comprises transferring the NFT or the FT to a player digital wallet before the new game is released,
wherein providing the plurality of digital game assets comprises: providing a physical object that comprises NFT data, wherein the physical object comprises the FT and wherein, responsive to redeeming the FT, the NFT is transferred to the player; and providing the plurality of digital game assets that correspond to a new game before the new game is released for public access comprises providing a mystery item that is available for purchase before the new game is released, wherein the mystery item comprises a prerelease NFT; and
collect player data corresponding to the player based on usage of the digital game asset by the player.
